(19) United States
(12) Patent Application Publication
(10) Pub. No.: US 2022/0402193 A1
(43) Pub. Date: Dec. 22, 2022

(54) A METHOD FOR IMPRINTING MICROPATTERNS ON A SUBSTRATE OF AN ORGANIC POLYMER

(71) Applicant: B.G. NEGEV TECHNOLOGIES AND APPLICATIONS LTD., AT BEN-GURION UNIVERSITY, Beer-Sheva (IL)

(72) Inventors: Mark SCHVARTZMAN, Tel Aviv (IL); Maor ROSENBERG, Hod HaSharon (IL)

(73) Assignee: B.G. NEGEV TECHNOLOGIES AND APPLICATIONS LTD., AT BEN-GURION UNIVERSITY, Beer-Sheva (IL)

(21) Appl. No.: 17/770,532

(22) PCT Filed: Oct. 15, 2020
(86) PCT No.: PCT/IL2020/051097

§ 371 Date: Apr. 20, 2022

Related U.S. Application Data
(60) Provisional application No. 62/925,241, filed on Oct. 24, 2019.

(51) Int. Cl. B29C 59/02; B29C 71/00; B29C 33/42; B29C 33/40

(52) U.S. Cl. CPC B29C 59/022; B29C 71/0009; B29C 33/424; B29C 33/40; B29K 2023/00

(57) ABSTRACT

A method for nanoimprinting a pattern on an organic polymer substrate, comprising: (a) preparing a soft operational mold, the operational mold comprising a pattern to be replicated to the substrate; (b) soaking the operational mold in a solvent to produce diffusion of solvent to the mold; (c) removing the operational mold from the solvent, and placing it on a surface of the organic polymer substrate to form a structure, and simultaneously (i) heating the structure to a temperature T<Tg, where Tg is the glass transition temperature of the organic polymer; and (ii) applying controlled pressure in a range of 20-300 psi on the mold to effect a penetration into the surface of the organic polymer substrate, thereby to replicate the pattern of the mold to the surface of the substrate; and (d) separating the operational mold from the patterned substrate.

### FIELD OF THE INVENTION

The invention relates to the field of micro-imprinting. More specifically, the invention relates to a method for imprinting micropatterns on a flat or curved organic polymer body.

### BACKGROUND OF THE INVENTION

Nanoimprint lithography is a widely used technique for shaping in a nano-scale (or micro-scale) body surfaces, such as optical components, electronic devices, photonic nanostructures, etc. Soft nanoimprinting is a versatile, high-throughput, and cost-effective nanolithography technique in which a nano-scale pattern is mechanically transferred onto a resist by use of an elastomeric mold. Given the mechanical flexibility of soft molds, the soft imprint technique can produce high-resolution nanostructures in UV-curable polymer films deposited on substrates with unconventional geometry, such as lenses and optical fibers. However, direct patterning of thermo-formable substrates with functional nanostructures is impractical by existing techniques due to a global substrate-deformation. The nanoimprint lithography technique combines (a) nanopatterning with a resolution and minimal feature size down to single nanometers; (b) scalability and high throughput; and (c) can be performed by relatively simple and cost-effective equipment. Therefore, nanoimprint is a preferable approach for device fabrication in numerous applications, such as plastic electronics, photovoltaics, photonics, and biomimetics. Nanoimprint, in principle, can be applied to a variety of thermoplastic and UV curable resist materials, using either rigid or soft molds. A soft mold has been mostly used to pattern a non-planar surface, which is challenging for conventional lithography techniques, such as photolithography or electron-beam lithography. Ever since its introduction, nanoimprint lithography has been mainly used to produce resist-masks, whose pattern is transferred into the underlying substrate, for example, by plasma etching, or by metal-deposition followed by liftoff. However, direct patterning of functional bodies on organic polymer substrates that are commonly used, for example, in solar cells, lasers, LEDs, lenses, and facets of waveguides, have not become practical yet. Current nanoimprinting techniques can pattern an organic polymer substrate only by applying a thin film of a UV-resist, or by applying a thermoplastic resist onto a solid substrate made of inorganic material, such as silicon or glass. In the latter case, the imprinting temperature must be higher than the glass transition temperature, to allow pattern transfer from the mold to the resist. Notably, applying a resist-film onto a polymer substrate means that the patterning is performed not on the substrate itself, but rather on a layer of “foreign” material. This procedure often complicates the fabrication process and substantially limits the choice of materials. For example, (a) this technique requires the use of film material having strong adhesion to the underneath substrate; and (b) it requires the use of film and substrate materials having similar thermal expansion coefficients to avoid mechanical stresses during thermal cycles, resulting in cracks and delamination of the resist film; and (c) moreover, in optical applications there is often a necessity to match the refractive index of the imprinted film with that of the substrate, to avoid the formation of an undesired optical interface. To summarize, it would be highly preferable in many applications to directly micro-pattern the substrate's surface while avoiding the application of foreign material (such as a resist film).

Direct patterning by hot embossing of polymer substrates has been demonstrated, yet mostly for features sized in the micron scale and above. Chen et al., Soft Mold-Based Hot Embossing Process for Precision Imprinting of Optical Components on Non-Planar Surfaces, Opt. Express 2015, 23, 20977 has recently demonstrated hot embossing of curved substrates using a soft mold. However, attempts to reproduce features sized below the micron scale resulted only in partial pattern transfer. Furthermore, to achieve even a partial pattern transfer, a temperature far above the glass transition point of the embossed polymer had to be applied, resulting in a significant thermal expansion of the PDMS (polydimethylsiloxane, a type of soft silicon) mold, and as a result, a distortion of up to 15%. Still, the main constrain of hot embossing is the compromise between the pattern quality and maintenance of the substrate shape, namely, embossing at a temperature slightly above the glass transition point yields an incomplete pattern transfer while embossing at a higher temperature deforms the substrate. Such deformation is often intolerable, primarily when the substrate is used as an optical component, such as a lens.

It is an object of the present invention to provide a method for direct surface patterning of microstructures on an organic polymer substrate.

It is another object of the invention to provide a soft nanoimprint technique for patterning organic polymer bodies.

It is still another object of the invention to provide a soft nanoimprint technique for patterning organic polymer bodies, which is simple, scalable, and applied in a high-throughput manner.

It is still another object of the invention to provide a soft nanoimprint technique for patterning organic polymer bodies, having curved or flat surfaces.

It is still another object of the invention to provide a soft nanoimprint technique for patterning organic polymer bodies' surfaces to obtain an anti-reflective surface.

Other objects and advantages of the invention will become apparent as the description proceeds.

### SUMMARY OF THE INVENTION

The invention relates to a method for nanoimprinting a pattern on an organic polymer substrate, comprising: (a) preparing a soft operational mold, the operational mold comprising a pattern to be replicated to the substrate; (b) soaking the operational mold in a solvent to produce diffusion of solvent to the mold; (c) removing the operational mold from the solvent, and placing it on a surface of the organic polymer substrate to form a structure, and simultaneously (i) heating the structure to a temperature T<T_{g}, where T_{g} is the glass transition temperature of the organic polymer; and (ii) applying controlled pressure in a range of 20-300 psi on the mold to effect a penetration into the surface of the organic polymer substrate, thereby to replicate the pattern of the mold to the surface of the substrate; and (d) separating the operational mold from the patterned substrate.

In an embodiment of the invention, the operational mold is made of silicon rubber, such as PDMS.

The pattern may be imprinted, for example, on a polymer characterized by T_{g}>100° C., e.g., in the range from 100 to 200° C. The temperature T at which the imprinting is performed is generally at least 10° C. lower than the T_{g} of the polymer substrate, e.g., from 20° C. to 80° C. lower, e.g., 30° C. to 70° C. lower than the T_{g} of the polymer substrate. The term polymer, as used herein, includes homopolymers and copolymers. Virtually every thermoplastic polymer in commercial use contains additives. The term polymer, as used herein, of course, includes additives-incorporated polymers. According to the invention, suitable polymers to be imprinted include polyolefins (including cyclic olefins), polycarbonates, and poly(meth)acrylates.

In an embodiment of the invention, the solvent is selected from the group of (optionally substituted) aromatic hydrocarbons, e.g., benzene and substituted benzene, e.g., alkyl-substituted benzene such as toluene and xylene, or any other organic liquid capable of softening (dissolving) the organic polymer upon penetration into the surface layer of the substrate under the conditions reported herein.

In an embodiment of the invention, the heat provided to the structure is conductive, convective, or radiative heat transfer.

In an embodiment of the invention, the imprinted pattern is anti-reflective.

In an embodiment of the invention, the imprinted pattern is super-hydrophobic.

In an embodiment of the invention, the substrate is flat or curved.

In an embodiment of the invention, the polymer substrate is a polycarbonate, the operational mold is made of PDMS, the solvent loaded onto the mold is toluene, and T is from 60° C. to 90° C.

In an embodiment of the invention, the polymer substrate is a cyclic polyolefin, the operational mold is made of PDMS, the solvent loaded onto the mold is toluene and T is from 80° C. to 120° C.

### BRIEF DESCRIPTION OF THE DRAWINGS

In the drawings:

FIGS. 1a and 1b illustrate in schematic form typical problems that are associated with prior art techniques for nanoimprint on organic polymers substrates;

FIG. 1c illustrates in schematic form a perfect nanoimprint, as is obtained by the method of the present invention;

FIG. 2 generally shows a technique for a soft nanoimprint on a surface of an organic polymer body (flat or curved), according to a first embodiment of the invention;

FIG. 3 generally illustrates a procedure for the preparation of an operational mold;

FIG. 4a shows a result of an imprint process on a curved lens;

FIGS. 4b and 4c show SEM images of nanoimprinted high-resolution patterns;

FIGS. 5a-5f show experimental results of a procedure for producing a moth-eye anti-reflective coating on a Zeonex® substrate surface by the invention's procedure. FIGS. 5a and 5b show 2D AFM images of the used mold and the imprinted polymer, respectively. FIGS. 5c and 5d show 3D AFM and SEM images of the imprinted polymer, respectively. FIG. 5e is a photographic image of a flower as seen via an optical polymeric substrate whose central square was nanoimprinted by the invention's anti-reflective process. FIG. 5f shows the reflection spectra of bare and imprinted polymer substrates, respectively;

FIGS. 6a and 6b show 2D and 3D AFM images of nanoimprinted polycarbonate, respectively;

FIG. 6c is a photographic image of a lens with an imprinted anti-reflective square in the middle; and

FIG. 6d shows a reflection spectra on bare and imprinted polycarbonate, respectively.

### DETAILED DESCRIPTION OF PREFERRED EMBODIMENTS

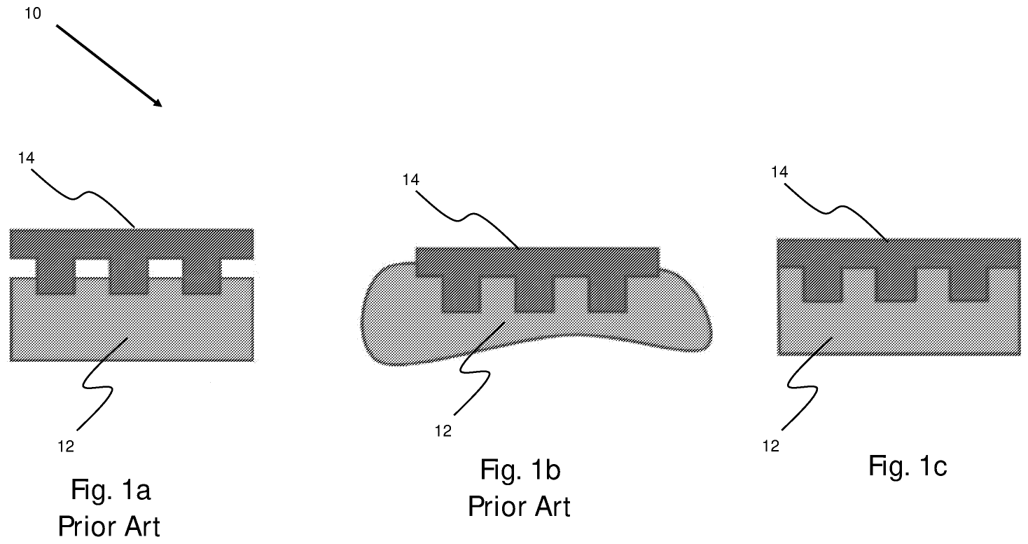

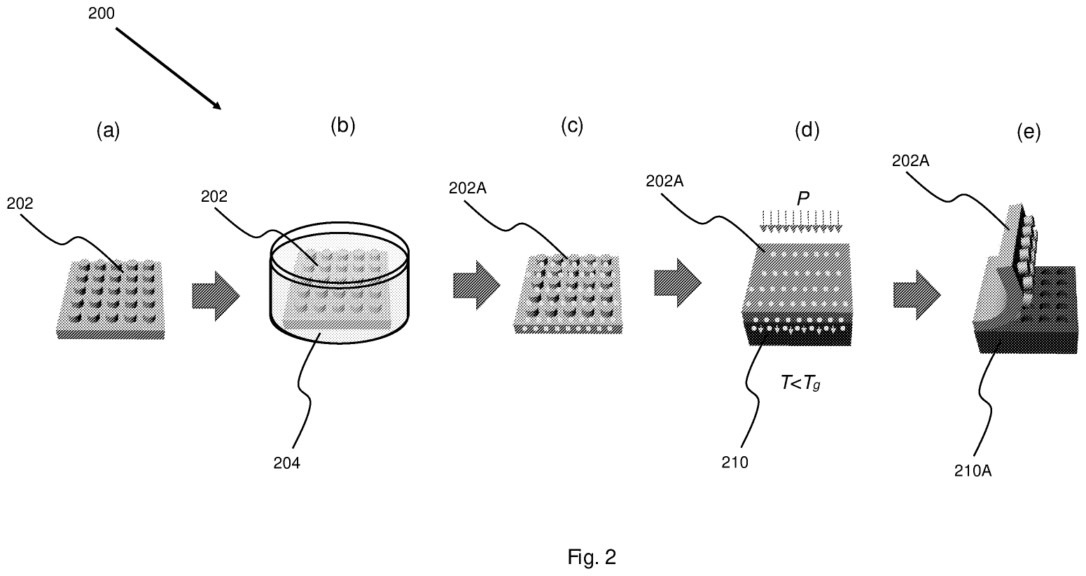

The invention provides a soft nanoimprint technique on a surface of an organic polymer body, either flat or curved. In another aspect, the invention provides a new nano-fabrication approach that allows a direct nanoimprint on a thermoplastic substrate surface with full pattern transfer while avoiding the deformation of the imprinted substrate shape. FIGS. 1a-1c illustrate typical problems that are associated with a soft nanoimprint process on an organic polymer substrate 12. The conventional nanoimprint process utilizes a flexible soft mold 14 to transfer a pattern from the mold to the surface of substrate 12. Typically, a soft nanoimprint process involves controlled heating of one or more of the substrate 12 or the mold 14, while simultaneously applying a force on the surface of mold 14. The prior art has not yet provided a successful nanoimprinting technique on an organic polymer substrate, given some delicate characteristics of the materials involved in both the substrate and the mold. An insufficient heating of the mold-substrate structure (14 and 12, respectively) or insufficient pressure on the mold 14 yields a partial transfer of the pattern to the substrate, as shown in FIG. 1a. On the other hand, overheating the structure or overpressure on the mold causes the deformation of substrate 12, as shown in FIG. 1b. The art has not yet provided a successful soft imprint technique that assures a perfect pattern transfer (as illustrated in FIG. 1c) from mold 14 to an organic polymer substrate 12 while avoiding either partial transfer (as shown in FIG. 1a) or deformation of the substrate (as shown in FIG. 1b).

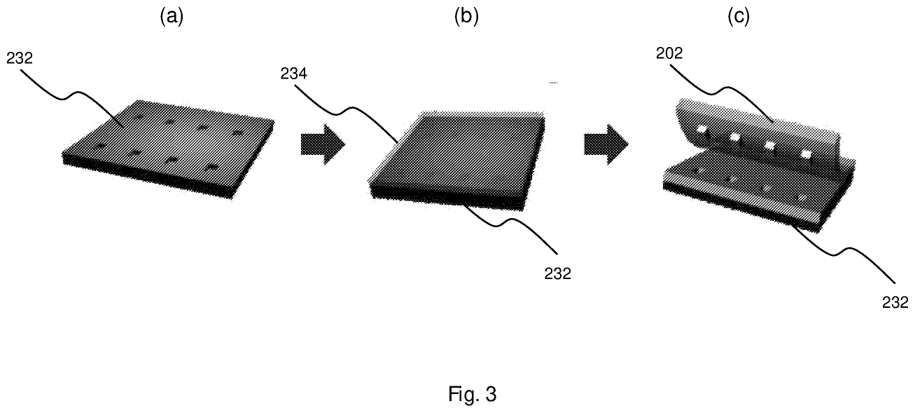

FIG. 2 generally illustrates a technique 200 for nanoimprinting on a surface of an organic polymer substrate, according to an embodiment of the present invention. In step (a), an operational mold 202, made for example, from PDMS, is prepared. The manner of preparation of the operational mold is conventional—a detailed example will be provided hereinafter. In step (b), mold 202 is soaked in a solvent 204, such as toluene or benzene. The inventors have found that a soaking period in the order of 1 minute is, in many cases, sufficient. During this period, solvent 204 is absorbed within operational mold 202. In step (c), the operational mold 202A, which now includes absorbed solvent 204, is removed from solvent 204 and is placed in step (d) above the surface of an organic polymer body 210 to form a structure. Then, still in step (d), a pressure P and heat T are simultaneously applied to the structure. The heat may be supplied in a conductive form, for example, by placing the structure above a heating element. Alternatively, the structure may be heated by convective heat transfer, e.g., by placing it within an oven or by radiate heat transfer, e.g., by using an infrared lamp. In all the above examples, the temperature of the polymer body must be monitored and controlled. Solvent 204, previously absorbed within the operational mold 202A, diffuses out of the mold during the imprint and is absorbed within a thin surface layer of organic polymer body 210, softening this thin layer and producing a plasticizing effect by reduction of the glass transition point of the thin layer. Thus, while the polymer's plasticized surface is imprintable at a temperature below the glass transition point of the raw organic polymer, the bulk of the substrate is not at all affected by the imprint. A heat of T<T_{g} at the interface between mold 202 and body 210 is sufficient to result in a successful imprint, with no deformation (T_{g} is the glass transition temperature of the organic polymer body). Next, in step (e), the structure is cooled down, followed by separation of the operational mold 202 from the structure to provide a successfully imprinted organic polymer body 210A, as shown in step (d). The imprinting technique of FIG. 2 has achieved excellent results, as will be elaborated hereinafter. The novel nanoimprint process of the invention allows a direct imprint on an organic polymer substrate with features size at the sub-20 nm scale. Such a size-scale is comparable to that of the state-of-the-art thermal nanoimprint of thin films, which, as noted above, suffers from significant drawbacks. The inventors directly imprinted sub-wavelength anti-reflective moth-eyes nanostructures on a surface of an optical organic polymer substrate and showed that it effectively attenuates the surface reflection. The inventors also demonstrated a direct nanoimprint on a curved organic polymer surface by imprinting moth-eye anti-reflective nanostructures onto a polymeric optical lens glasses.

Experiments and Further Discussion

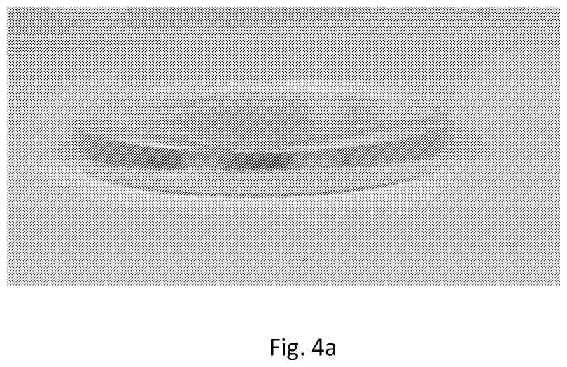

To explore the miniaturization applicability of the direct-resistless nanoimprint process of the invention, the inventors created an elastomeric mold 202 patterned with various shapes whose dimensions were in the order of 20 nm. For this purpose, the inventors first fabricated a master mold by electron-beam patterning of a positive resist on a silicon substrate. The inventors then replicated a soft mold from this master mold by sequential application of hard and soft PDMS. More specifically, and as shown in FIG. 3, the inventors produced a master mold 232 with ultra-fine features by electron beam patterning of a positive-tone organic resist on a silicon substrate (step (a) of FIG. 3). To prepare the hybrid h-PDMS/PDMS mold, the inventors first mixed and degassed 3.4 g of a vinyl PDMS prepolymer (VDT-731, Gelest Corp., www.gelest.com), 18 μL of a Pt catalyst (platinum divinyl-tetramethyl disiloxane, SIP6831.1, Gelest Corp.), and one drop of a modulator (2,4,6,8-tetramethyl-tetravinylcyclotetrasiloxane, 87927, Sigma-Aldrich, www.sigmaalrich.com). Then the inventors added 1 gr of hydrosilane prepolymer (HMS-301, Gelest Corp.) and gently stirred the solution. The inventors then spin-coated the solution onto the master mold at 1000 rpm for 40 seconds, degassed in a vacuum, and baked (Step (b) of FIG. 3). Finally, the inventors poured an additional layer of a standard PDMS (Sylgard 184, 10:1) onto the hard-PDMS layer, vacuumed and cured at 60° C. for 2 hrs to form a coating 234. Finally, in step (c), the inventors peeled the coating 234 off the master mold to create a composite mold 202, also referred to as the “operational mold”. The procedure of FIG. 3 for the preparation of the operational mold 202 is only an example, as the operational-mold may be prepared in another conventional manner.

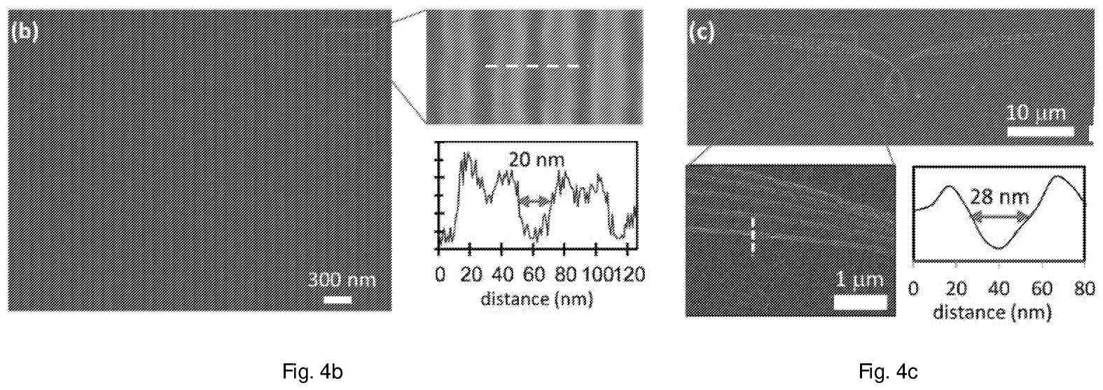

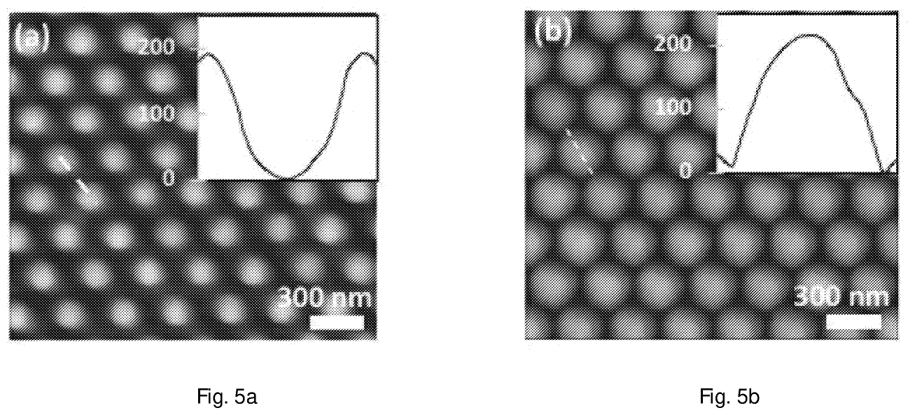

The inventors then continued to perform the procedure of FIG. 2. The procedure was repeated with several polymer substrates and operational molds, as elaborated hereinafter. In one instance, and to directly imprint a polymer substrate, the inventors first soaked the operational mold in toluene for 5 minutes and dried it with nitrogen. Then, the inventors brought the operational mold 202A into contact with a circular substrate (diameter of 2.54 cm) of an optical cyclo-olefin polymer (Zeonex®, Zeon Inc.) and imprinted it with a custom-made nanoimprint tool by applying a pneumatic pressure of 50 psi and a temperature of 100° C. for 10 minutes. By the end of the imprint process, the inventors brought the substrate and the mold to room temperature by natural cooling, released the pressure, and gently peeled the mold off the substrate. According to the vendor's website, the glass transition temperature of the used optical polymer is 138° C. Naturally, as expected, imprinting at 100° C. did not change the polymer substrate's shape, as shown in FIG. 4a. While not affecting the bulk substrate's shape, the inventors found that its surface was faithfully imprinted with the desired pattern, as shown in FIGS. 4b and 4c. FIGS. 4b and 4c illustrate two types of imprinted nanopatterns, nano-grating, and curved lines, respectively. The insets show high magnifications, respectively, of the imprinted lines, and grey-scale profile plots of the high-magnified images used to estimate the lines' exact width (defined as full-width half-maximum of the profile). An analysis of the imprinted substrate's size and shape has revealed that the nanopattern faithfully replicated the original master's pattern, with no detectable distortions. The achieved 20 nm feature size is close to that obtained by the state of the art nanoimprint that applies a UV or a thermal process over resist films (namely, using a foreign layer which is adhered to the substrate). The line edge roughness (LER) of the imprinted features, which is notable on a high-magnification SEM (Scanning Electron Microscope) images, is about 2.2 nm. To test whether the obtained LER is not an imaging artifact resulting from the polymer's charge and heat during SEM inspection, the inventors also measured the LER of imprinted lines with a width of 200 nm and found it to be about 25 nm. In these two cases, the LER value is in proportion with the line width. The inventors assumed that it was caused by the patterning process rather than by the SEM imaging. To confirm that the applied nanoimprint process has not deformed the imprinted substrate's global shape, the inventors characterized the flatness using laser scanning profiler and profilometry. The inventors compared the obtained flatness with that of a bare substrate and found that the nanoimprint process has not caused any bow or another type of substrate deformation. This finding is of critical importance, particularly for optical applications in which the global shape of the imprinted optical components, such as lenses, must be precisely maintained.

The high magnification SEM of FIGS. 4b and 4c, as well as the measured surface profile and measured Full-Width-Half-Maximum (FWHM), indicate the achieved minimal feature size. The PDMS material tends to swell upon the absorbance of organic solvents. Naturally, this swelling could have altered the dimensions of the imprinted pattern. To verify whether a pattern distortion existed, the inventors first estimated how much toluene was absorbed within the operational mold after 5 minutes of soaking. The inventors measured the weight and volume of the PDMS mold before and after the soaking. It was found that the mold volume increased by about 10% due to the soaking and that the amount of the absorbed toluene was about 0.12 g per cm³ of PDMS. It was also found that the degree of the swell and the amount of absorbed toluene decreased by more than half after the actual imprint process. The inventors concluded that the mold shrunk during the imprint process due to the diffusion of a significant amount of the toluene. Naturally, a part of the diffused toluene was absorbed within the polymer surface and produced a plasticizing effect there. To estimate the possibility of pattern distortion due to the mold swell, the inventors measured the imprinted grid's periodicity, whose nominal periodicity was 80 nm, as defined by the master mold. To maximize the periodicity value's precision, the inventors measured the Full-Width-Half-Maximum (FWHM) of the grid profile. It was found that the periodicity of the imprinted pattern has increased uniformly across the pattern to 81.3 nm, an increase of 1.17% compared to the original 80 nm periodicity at the grating of the master mold. This increase of grating periodicity is inconsistent with the observed 10% of the mold expansion after the soaking. The inventors believe that during the imprint, most of the absorbed solvent has left the mold; thus, the mold volume, particularly its surface, returned to its original dimensions. The inventors also believe that the observed pattern distortion, which is minute given that a soft and flexible mold was used, can be further reduced by optimizing the process parameters, such as the amount of absorbed toluene. The inventors repeated the measurements after a few days and found that the pattern dimensions stay consistent. This observation confirms that any possible desorption of toluene leftovers within the imprinted polymer does not affect the pattern. The solvent transfer from the mold to the imprinted polymer was further investigated to optimize the direct and resistless nanoimprint process and select process parameters. The inventors used a basic diffusion model to describe the transfer of toluene from the mold to within the imprinted polymer's body during the imprint process. For this purpose, the inventors assumed that the toluene concentration at the polymer-mold interface is constant during the imprint and that this concentration is equal to the bulk toluene concentration within the soaked mold. This assumption was used as a boundary condition for a diffusion equation that described the toluene migration to the polymer. Given a diffusion coefficient of toluene in a cyclo-olefin polymer of 7.5*10⁻¹² cm² per second, and neglecting a possible effect of a surface topography created by the mold, the inventors obtained a characteristic diffusion length of 670 nm after 10 minutes of the imprint. Naturally, the diffusion profile propagates with time, resulting in a toluene-contained layer of a few microns at the polymer surface. It is difficult to quantitatively predict the effect of toluene concentration in the polymer at the polymer glass-transition temperature. Still, the experimental results clearly showed that the absorbed toluene effectively plasticized the polymer and allowed its imprint at a temperature that was about 40° C. below the raw polymer's glass transition temperature. Furthermore, the plasticized layer's thickness, as predicted by a simplified model, is a few microns. This observation confirms that the invention's resistless imprint process is applicable for producing 3D features with a high aspect ratio and vertical dimensions on the micron scale.

The new imprint approach of the invention opens a pathway to many applications unachievable to date. An important application of nanoimprint lithography, which requires features with heights of hundreds of nm and above, is moth-eye anti-reflective coating. This type of bio-inspired optical nanostructure, first discovered on the cornea of nocturnal moth Spodoptera eridania about half a century ago, is based on dense arrays of subwavelength nipples that produce a layer with an effective index gradient. Compared to traditional thin-film based anti-reflective coatings, moth-eye anti-reflective coatings are broadband, omnidirectional, and have low laser damage thresholds and better resistance to thermal shocks. Nanoimprint lithography, which combines high throughput with sub-wavelength patterning features, is ideal for fabricating moth-eye anti-reflective coating for many applications, such as solar cells. Sill, surface patterning of functional materials with a nanoimprinted moth-eye anti-reflective coating has mostly required the pattern transfer from an imprinted resist to the substrate by etching. Yet, in the case of polymeric optical surfaces, the fabrication of moth-eye anti-reflective coating could be, in principle, greatly simplified by direct nanoimprint. In such a case, there would be no necessity to cover the polymer substrate with a “foreign” material whose optical properties are different from those of the substrate. This procedure complicates the optical design and degrades its performance. Such a direct imprint of anti-reflective nanostructures, however, has not been demonstrated yet.

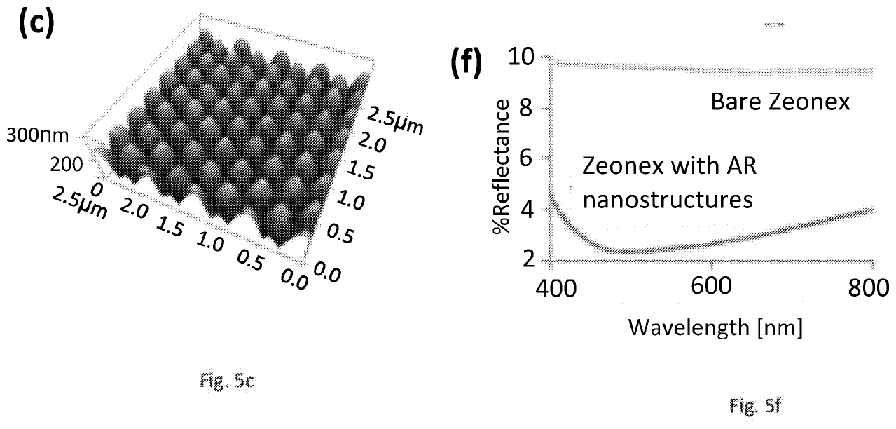

The inventors have directly nanoimprinted a surface of an optical polymeric substrate (Zeonex®) with a moth-eye anti-reflective coating. FIGS. 5a-5f show the result of the procedure for producing a moth-eye anti-reflective coating on a surface of a Zeonex® substrate, as performed. FIGS. 5a and 5b show 2D AFM images of the used mold and the imprinted polymer, respectively. The insets show the 2D profile, to demonstrate that the features have the same height. FIGS. 5c and 5d show 3D AFM and SEM images of the imprinted polymer, respectively. FIG. 5e is a photographic image of a flower as seen via the optical polymeric substrate whose central square was nanoimprinted by the invention's anti-reflective process. FIG. 5f shows the reflection spectra of bare and imprinted polymer substrates, respectively.

The inventors first replicated a hybrid h-PDMS/PDMS operational mold from a commercial Nickel master mold patterned with moth-eye conical nanostructures (NIL Technology). Then the operational mold was used for a direct imprint. To perform the nanoimprint, the inventors first soaked two PDMS molds in toluene, then mechanically pressed them against the substrate from both of its sides using a set of mechanical clamps, and placed the pressed substrate-mold sandwich in an oven heated to 80° C. for 10 minutes. While the depth of the relief features for the PDMS mold was 200 nm, as shown in FIG. 5a, the respective heights of the imprinted features were found to be 200 nm as well, as shown in FIG. 5b. Furthermore, the inventors found that the nano-array periodicity was exactly 347 nm for both the mold and the imprint. These two findings clearly show that the pattern was replicated in very high fidelity, at least since the nanoimprint process was performed at a relatively low temperature, a temperature in which the expansion of the PDMS mold is minimized.

FIGS. 5c and 5d show 3D AFM and SEM images of the imprinted features, respectively, confirming the high-quality of the pattern transfer. Again, the global shape of the imprinted substrate was not at all affected by the imprint process. The imprinted anti-reflective nanostructures effectively increase the transmission of the used optical polymer substrate. Here, the used nanoimprint mold was about 1.5 cm×1.5 cm in size. Thus, the inventors imprinted a square in the middle of a Zeonex® substrate with a diameter of 2.54 cm. The difference in the optical transmission between the imprinted and the non-imprinted areas is shown in FIG. 5e. To quantify the optical effect of the imprinted anti-reflective nanostructures, the inventors measured the reflection spectrum of the imprinted Zeonex® substrate in the visible range using a spectrophotometer (Cary 5000, Agilent) and compared the measurement to that of a bare substrate (FIG. 5f). It can be seen that the moth-eye anti-reflective nanostructure pattern, as directly imprinted, provides a broadband reduction in the reflection over the visible spectrum. The fact that a commercial master mold designed for use with generic materials was not ideal. The obtained anti-reflective performance could most probably be improved by developing optimized anti-reflective nano-arrays while specifically matching the mold characteristics to the Zeonex® material's refractive index.

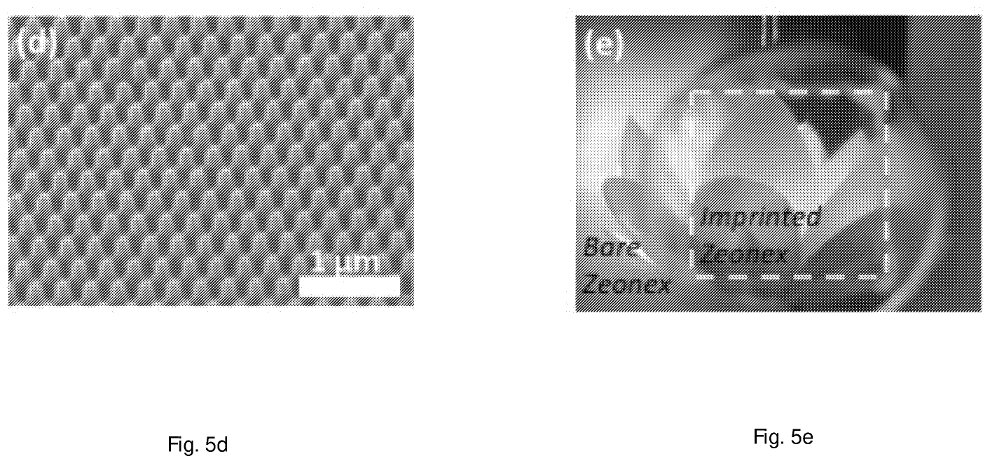

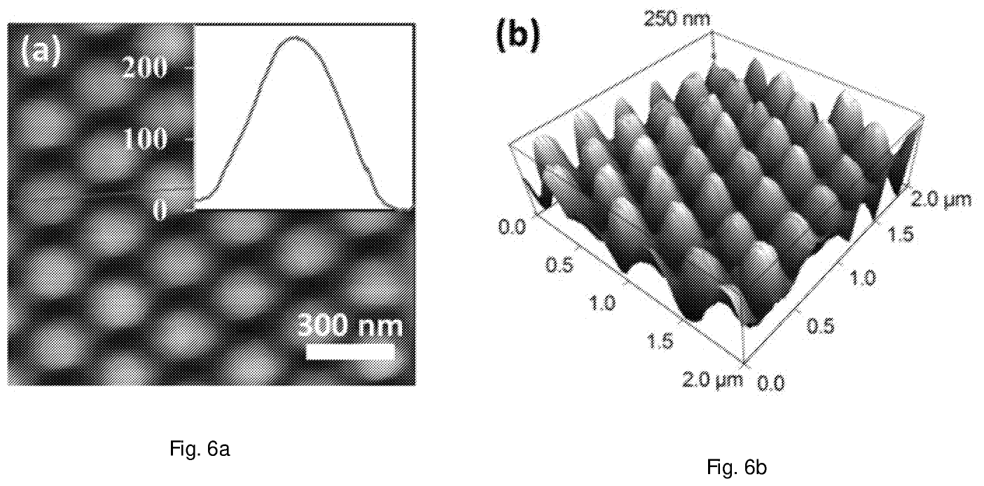

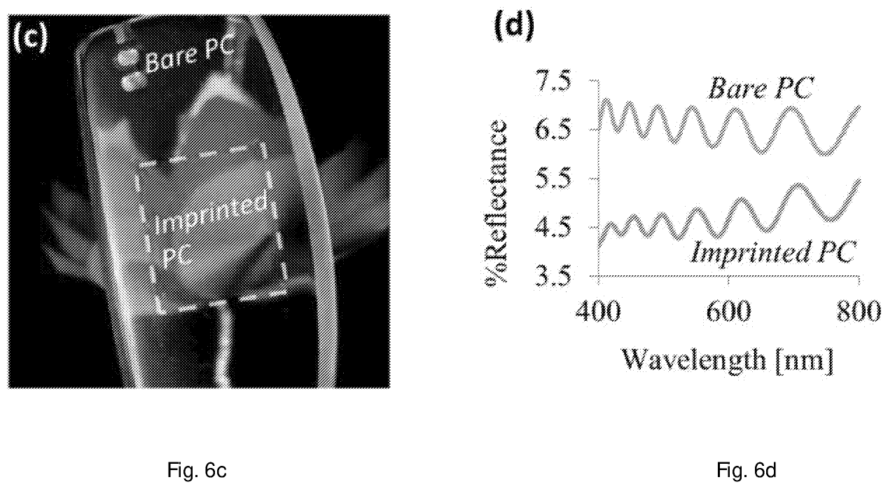

As previously mentioned, the most significant benefit of using soft nanoimprint molds resides in their ability to pattern non-planar surfaces. To demonstrate that the invention's imprinting approach also applies to non-planar surfaces, the inventors produced a similar moth-eye anti-reflective coating on a commercial lens of optical glasses made of polycarbonate (PC), whose radius of curvature was 81 mm and 27 mm (vertically and horizontally, respectively). Here, the inventors used the similar mechanical setup previously described for Zeonex, based on clamps, to imprint the anti-reflective nanostructures on the lens's convex side. FIGS. 6a and 6b show 2D and 3D AFM images of nanoimprinted polycarbonate, respectively. FIG. 6c is a photographic image of a lens with an imprinted anti-reflective square in the middle. FIG. 6d shows a reflection spectra on bare and imprinted polycarbonate, respectively, as compared.

Notably, the glass transition point of polycarbonate is about 150° C. The inventors presumed that a commercial plasticizer was added to the used polycarbonate to facilitate the lens injection molding; however, it was unknown to what extent this addition lowered the glass transition point. Still, the lens did not change its global shape at the imprinting temperature of 80° C. Again, as the imprinting mold was about 1.5 cm×1.5 cm in size, the inventors could not imprint the entire lens, but only its central part. This imprinted square region at the mold center is visible in the lens's photography because it is more transparent than the surrounding areas. The microstructural analysis of the imprinted area and the anti-reflective performance prove that the moth-eye anti-reflective coating of the invention can be imprinted on curved or flat substrates in substantially the same quality.

To summarize, the invention provides a new approach for a direct resistless nanoimprint on polymeric substrates. The procedure of the invention facilitates the surface nanostructuring of polymeric substrates. A significant advantage of this approach is that it is performed at a temperature T_{sg}<T<T_{g}, which is much lower than a temperature above T_{g} at which a conventional nanoimprint process is performed. T_{g} is the organic polymer's glass transition temperature, and T_{sg} is a glass transition temperature of the substrate's surface. The temperature T_{sg} results to be significantly lower than T_{g} due to the diffusion of the solvent into the mold, and therefore T can be much lower than T_{g} as well. The inventors have found no necessity to measure or determine the temperature T_{sg} to carry out the invention, as an operational temperature of T, which is lower by 20° C. to 80° suffice. This temperature is significantly lower than a temperature higher than T_{g}, which should have been typically used in such a process. It eliminates the possibility of the substrate's global deformation and minimizes any possible pattern distortion due to the used elastomeric mold's thermal expansion. The inventors showed herein nanoimprint of two different polymers. The invention's nanoimprint process applies to any thermoplastic (organic) polymer by selecting an appropriate solvent for each case. The versatility of the invention process and its compatibility with numerous polymer materials and substrates of arbitrary forms opens a route to many applications requiring precise scalable nanostructures of polymer surfaces.

While some embodiments of the invention have been described by way of illustration, it will be apparent that the invention can be carried into practice with many modifications, variations, and adaptations, and with the use of numerous equivalent or alternative solutions that are within the scope of persons skilled in the art, without departing from the spirit of the invention or exceeding the scope of the claims.

1. A method for nanoimprinting a pattern on an organic polymer substrate, comprising:
preparing a soft operational mold, the operational mold comprising a pattern to be replicated to the substrate;
soaking the operational mold in a solvent to produce diffusion of solvent to the mold;
removing the operational mold from the solvent, and placing it on a surface of the organic polymer substrate to form a structure, and simultaneously (i) heating the structure to a temperature T<T_{g}, where T_{g} is the glass transition temperature of the organic polymer, and (ii) applying controlled pressure on the mold to effect penetration to the surface of the organic polymer substrate, thereby to replicate the pattern of the mold to the surface of the substrate; and
separating the operational mold from the patterned substrate.

2. The method of claim 1, wherein T<T_{g} by 20° C. to 80° C.

3. The method of claim 1, wherein the polymer is a polyolefin or a polycarbonate.

4. The method of claim 1, wherein the operational mold is made of silicon rubber.

5. The method of claim 1, wherein the solvent comprises an aromatic hydrocarbon.

6. The method of claim 5, wherein the aromatic hydrocarbon is benzene or alkyl-substituted benzene.

7. The method of claim 1, wherein the heat provided to the structure is conductive, convective, or radiative heat transfer.

8. The method of claim 1 wherein the imprinted pattern is anti-reflective.

9. The method of claim 1 wherein the imprinted pattern is super-hydrophobic.

10. The method of claim 1 wherein the substrate is flat or curved.

11. The method of claim 1, wherein the polymer substrate is a polycarbonate, the operational mold is made of PDMS, the solvent loaded onto the mold is toluene and T is from 60° C. to 90° C.

12. The method of claim 1, wherein the polymer substrate is a cyclic polyolefin, the operational mold is made of PDMS, the solvent loaded onto the mold is toluene and T is from 80° C. to 120° C.
